(19) United States
(12) Patent Application Publication
(10) Pub. No.: US 2012/0111098 A1
(43) Pub. Date: May 10, 2012

(54) 2- ACETAMIDE

(75) Inventor: Ana Gavaldá Escudé, Sant Cugat del Valles (ES)

(73) Assignee: MEDICHEM, S.A., Sant Joan Despi (ES)

(21) Appl. No.: 13/263,301

(22) PCT Filed: Apr. 6, 2010
(86) PCT No.: PCT/EP2010/054555

§ 371 Date: Nov. 11, 2011

Related U.S. Application Data
(60) Provisional application No. 61/166,940, filed on Apr. 6, 2009.

(51) Int. Cl. G01N 30/04

(52) U.S. Cl. 73/61.55

(57) ABSTRACT

The invention relates to 2-{2-amino-3-[hydroxy(phenyl)methyl]phenyl}acetamide, a process for its preparation, and its use as a reference marker and reference standard for analyzing the purity of nepafenac.

### BRIEF SUMMARY OF THE INVENTION

The invention relates to 2-{2-amino-3-[hydroxy(phenyl)methyl]phenyl}acetamide, a process for its preparation, and its use as a reference marker and reference standard for analyzing the purity of nepafenac.

### BACKGROUND OF THE INVENTION

Nepafenac (compound I) is the international common accepted name for 2-amino-3-benzoylbenzeneacetamide, and has an empirical formula of C₁₅H₁₄N₂O₂, and a molecular weight of 254.28 g/mol.

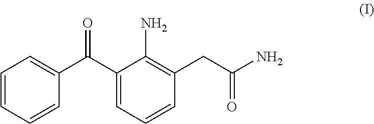

Nepafenac is a non-steroidal anti-inflammatory active pharmaceutical substance with analgesic activity. In the United States, nepafenac is marketed under the name Nevanac™, and is indicated for ophthalmic use.

The preparation of nepafenac and similar compounds is disclosed in U.S. Pat. No. 4,313,949 (“the '949 patent”), which is incorporated herein by reference. The synthesis of nepafenac described in this reference is depicted in Scheme 1.

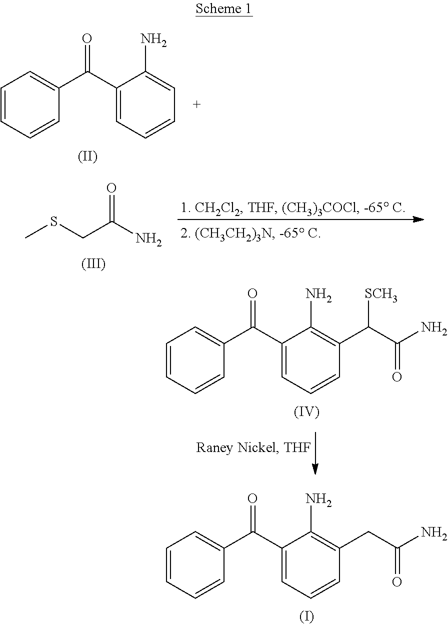

In particular, Example 2 of the '949 patent describes the preparation of nepafenac using 2-amino-3-benzoyl-α-(methylthio)-benzeneacetamide (compound of formula (IV)), as an intermediate compound, which is converted into nepafenac (compound I) via desulfurization using Raney nickel as a catalyst.

However, the present applicant has discovered that the preparation of nepafenac described in Example 2 of the '949 patent may produce nepafenac containing the impurity 2-{2-amino-3-[hydroxy(phenyl)methyl]phenyl}acetamide.

In view of the foregoing, there is the need for detecting and quantifying the 2-{2-amino-3-[hydroxy(phenyl)methyl]phenyl}acetamide impurity from samples of nepafenac.

### DETAILED DESCRIPTION OF THE INVENTION

In an embodiment, the invention relates to 2-{2-amino-3-[hydroxy(phenyl)methyl]phenyl}acetamide, compound of formula (V),

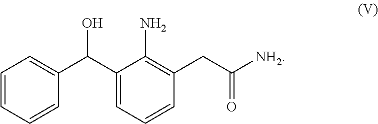

In another embodiment, the invention provides a process for preparing compound of formula (V), said process comprising: (i) treating a mixture of 2-amino-3-benzoylbenzeneacetamide, compound of formula I (i.e. nepafenac),

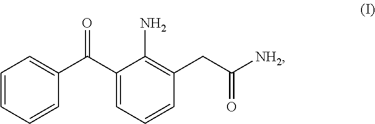

with a reducing agent in the presence of a solvent, and (ii) optionally, isolating compound (V) from the mixture.

The reducing agent of step (i) can be any reducing agent suitable for reducing the ketone group of compound (I) such as hydrogen, lithium aluminium hydride or sodium borohydride. Optionally, the step (i) can further comprise a metallic catalyst. The solvent is preferably a C₁-C₅ alcohol solvent, and more preferably is ethanol.

In a preferred embodiment, the invention provides a process for preparing 2-{2-amino-3-[hydroxy(phenyl)methyl]phenyl}acetamide, said process comprising (i) providing a mixture of 2-amino-3-benzoylbenzeneacetamide, compound of formula I (i.e. nepafenac), with sodium borohydride and ethanol, (ii) heating the mixture at reflux temperature during 2 hours, (iii) isolating compound (V) from the mixture, (iv) slurrying compound (V) twice in water, and (v) crystallizing compound (V) from ethanol.

In yet another embodiment, the invention provides the use of compound (V) as a reference marker to analyze the purity of nepafenac. The term “reference marker”, as used herein, refers to a compound that may be used in qualitative analysis to identify components of a mixture based on their position, e.g. in a HPLC chromatogram or on a Thin Layer Chromatography (TLC) plate.

In still yet another embodiment, the invention provides the use of compound (V) as a reference standard to quantify the amount of compound (V) in a sample of nepafenac.

In another embodiment, the invention provides a method of quantifying the amount of compound (V) present in a sample of nepafenac.

In another embodiment, the invention provides a method for analyzing the amount of compound (V) present in a sample of nepafenac using analytical HPLC, said method comprising: (i) measuring by HPLC the area under the peak corresponding to compound (v) in a sample of nepafenac having an unknown amount of compound (V); (ii) measuring by HPLC the area under a peak corresponding to nepafenac in a reference standard having a known amount of nepafenac and/or a known amount of compound (V); and (iii) determining the amount of compound (V) in the nepafenac sample by comparing the area calculated in step (i) with the area calculated in step (ii).

In another further embodiment, the invention provides an HPLC method for determining the amount of compound (V) in a sample of nepafenac, said method comprising: (i) combining a sample of nepafenac having compound of formula (V) with acetonitrile to form a solution, wherein the nepafenac is present in an amount of about 0.1-1.0 mg per milliliter of the solution; (ii) injecting the solution of step (i) into a C₁₈ column having equal to or less than 10 μm of particle size; (iii) eluting the sample from the column with a mixture of ammonium formate buffer, and acetonitrile as an eluent; and (iv) measuring the compound of formula (V) content of the sample with a UV detector at 245 nm wavelength.

In still another embodiment, the invention provides a process for analyzing the purity of a composition containing nepafenac comprising monitoring the amount of compound (V) in a sample of said composition.

In yet another embodiment, the invention provides a method for monitoring the presence of compound (V) in the reaction product obtained from the desulfurization reaction of 2-amino-3-benzoyl-α-(methylthio)-benzeneacetamide, compound of formula (IV).

The following examples further illustrate the invention but, of course, should not be construed as in any way limiting its scope.

### SPECIFIC EXAMPLES

### General Experimental Conditions

### HPLC Method:

The chromatographic separation was carried out in a Waters Sunfire C18, 5 μm, 4.6×150 mm column at 30° C.

The mobile phase A was a 10 mM ammonium formate buffer, pH 4.25, which was prepared from 0.63 g of HCOONH₄ in 1000 mL of water. The pH was adjusted to 4.25 with formic acid. The mobile phase was mixed and filtered through a 0.22 μm nylon membrane under vacuum.

The mobile phase B was acetonitrile.

The chromatograph was programmed as follows: Initial 0-30 minutes 30% mobile phase B, 30-40 minutes linear gradient to 32% mobile phase B, 40-65 minutes isocratic 32% mobile phase B, 65-70 minutes linear gradient to 30% mobile phase B and 70-80 minutes equilibration with 30% mobile phase B.

The chromatograph was equipped with a 245 nm detector, and the flow rate was 1 mL per minute. The test samples (10 μl) were prepared by dissolving the appropriate amount of sample in acetonitrile in order to obtain 0.5 mg per mL. The chromatogram was run for at least 65 minutes.

Approximate HPLC Retention Times:

| | | Relative |
|---|---|---|
| | Time | Retention |
| Compound | (minutes) | Time |
| Nepafenac (compound I) | 10.1 | — |
| 2-{2-amino-3-[hydroxy(phenyl)methyl]phenyl} | 4.3 | 0.43 |
| acetamide (compound V) | | |
| 2-amino-3-benzoyl-α- | 21.3 | 2.11 |
| (methylthio)benzeneacetamide (compound IV) | | |
| 2-aminobenzophenone (Compound II) | 44.7 | 4.43 |

The limit of detection (LOD): 0.0000916 mg/ml of compound (V).

### Example 1

### Preparation of 2-{2-amino-3-[hydroxy(phenyl)methyl]phenyl}acetamide (i.e. compound of formula V).

A mixture of 2-amino-3-benzoylbenzeneacetamide, compound (I), (21.0 g, 0.083 mol) and sodium borohydride (6.25 g, 0.165 mol) in ethanol (840 mL) was heated at reflux temperature during 2 hours. The reaction mixture was cooled to room temperature and filtered. The solid was slurried twice during 45 minutes with water (250 mL) and filtered. The solid was recrystallized from ethanol to yield 15.8 g (75%) of 2-{2-amino-3-[hydroxy(phenyl)methyl]phenyl}acetamide as a white solid.

Analytical data: m.p.: 198-199° C.; IR (cm⁻¹): 3354, 3302, 3175, 2926, 2856, 2796, 1673, 1629, 1449; ¹H NMR (400 MHz, DMSO-d₆): δ 7.50 (br s, 1H), 7.36 (dm, J=7.2 Hz, 2H), 7.29 (t, J=7.4 Hz, 2H), 7.21 (tt, J=7.2, 1.4 Hz, 1H,), 6.97-6.93 (m, 3H), 6.54 (t, J=7.6 Hz, 1H), 5.93 (d, J=4.4 Hz, 1H), 5.77 (d, J=4.4 Hz, 1H,), 5.11 (s, 2H), 3.26 (s, 2H); ¹³C NMR (100.6 MHz, DMSO-d₆): δ 173.0, 144.3, 144.1, 129.3, 128.5, 127.8, 126.6, 126.5, 126.4, 121.4, 115.9, 72.3, 39.4. C₁₅H₁₆N₂O₂: calculated 70.29%; H, 6.29%; N, 10.93%. Found 70.28%; H, 6.39%; N, 10.88%; MS (ESI+) calculated for C₁₅H₁₆N₂O₂ 256. Found 257. [M+H].

1-6. (canceled)

7. A method for determining the purity of a nepafenac sample comprising analyzing the sample for the presence of a compound of formula (V):

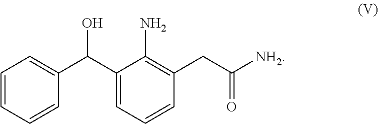

8. A method for determining the purity of a nepafenac sample comprising quantifying the amount of a compound of formula (V): 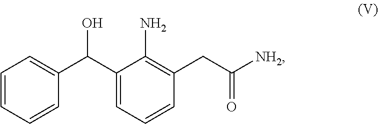
in the nepafenac sample utilizing a reference standard sample of a compound of formula (V).

9. A method of quantifying the amount of compound of formula (V): 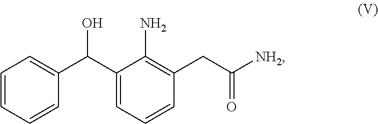
said method comprising:
(i) providing a sample of nepafenac containing an unknown amount of a compound of formula (V);
(ii) measuring by HPLC the area under the peak corresponding to compound of formula (V) in the nepafenac sample;
(iii) measuring by HPLC the area under a peak corresponding to nepafenac in a reference standard sample having a known amount of nepafenac and/or having a known amount of compound of formula (V); and
(iv) determining the amount of compound of formula (V) in the nepafenac sample of step (i) by comparing the area calculated in step (ii) with the area calculated in step (iii).

10. An HPLC method for determining the amount of compound of formula (V), as defined in claim 7, in a sample of nepafenac, said method comprising:
(i) combining a sample of nepafenac having a compound of formula (V) with acetonitrile to form a solution, wherein the nepafenac is present in an amount of 0.5 mg/mL of the solution;
(ii) injecting the solution of step (i) into a C₁₈ column, wherein said column has a particle size of less than or equal to 10 μm;
(iii) eluting the sample from the column with a mixture of ammonium formate buffer and acetonitrile; and
(iv) detecting the presence of the compound of formula (V) with a UV detector measuring at a wavelength of 245 nm.

11. A process for analyzing the purity of a composition containing nepafenac comprising monitoring the amount of compound of formula (V), as defined in claim 7, in a sample of said composition.

12. A method for monitoring the presence of compound of formula (V), as defined in claim 7, in a reaction product obtained from a desulfurization reaction of 2-amino-3-benzoyl-α-(methylthio)-benzeneacetamide, compound of formula (IV): 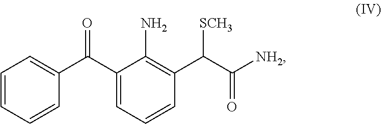
comprising detecting the presence of a compound of formula (V) in a sample of said reaction product.
